(19) United States
(12) Patent Application Publication
(10) Pub. No.: US 2010/0310337 A1
(43) Pub. Date: Dec. 9, 2010

(54) LOOSE RESISTANT BOLT STRUCTURE

(76) Inventor: Wen-Hsuan CHEN, Shulin City (TW)

Correspondence Address: Muncy, Geissler, Olds & Lowe, PLLC, 4000 Legato Road, Suite 310, FAIRFAX, VA, 22033, US

(21) Appl. No.: 12/481,149

(22) Filed: Jun. 9, 2009

(51) Int. Cl. F16B 35/04

(52) U.S. Cl. 411/417

(57) ABSTRACT

A loose resistant bolt structure is disclosed which includes a bolt unit and a buffer portion. The bolt unit includes an intermediate portion, a head portion at an end of the intermediate portion, and a threaded portion at an opposite end of the intermediate portion. The buffer portion surrounds the threaded portion and is located adjacent to an end of the bolt unit to form a distinct pitch on the threaded portion. When the threaded portion engages with a nut, the buffer portion is drawn, shrunk or twisted, producing elastic stress and torsion force, thereby securing the threaded portion to the nut and resisting loose therebetween, and will be able to avoid an inner thread of the nut caused damage during assembly.

### BACKGROUND OF THE INVENTION

(a) Field of the Invention

The present invention relates to a bolt, and particularly relates to loose resistant bolt structure.

(b) Description of the Prior Art

A prior art bolt, such as a spoke of a bicycle, is generally combined with a nut of a wheel rim by loose resistant glue or anti-disengagement plastic lacquer with coating for preventing from disengagement. However, this structure can not be detached or loosened to be readjusted after it is assembled.

In order to solve the problem, a loose resistant spoke is addressed. As seen from FIG. 5, the spoke 4 comprises an intermediate portion 41, a head portion 42 at an end of the intermediate portion 41, and a bent threaded portion 43 at an opposite end of the intermediate portion 41. When assembled, the head portion 42 of the spoke 4 is engaged with a wheel rim (not shown). The threaded portion 43 is engaged with a nut (not shown). This spoke 4 resists loose.

Because of restraint of the high stress while being assembled, the threaded portion 43, which has been bent, is pulled straight by external force. In this event, the threaded portion 43 can not resist loose. Moreover, the threaded portion 43 tends to damage inner threads of the nut. The bent structure of the threaded portion 43, in practice, can not take into effect for resisting loose.

### SUMMARY OF THE INVENTION

In view of the above, a main object of the present invention is to provide a loose resistant bolt structure which has a buffer portion forming a distinct pitch different from a pitch of the threaded portion, wherein when the threaded portion engages with a nut, the buffer portion is drawn, shrunk or twisted, producing elastic stress and torsion force, thereby securing the threaded portion to the nut, and avoiding an inner thread of the nut caused damage, and preventing from disengagement therebetween.

A loose resistant bolt structure in accordance with the present invention comprises a bolt unit and a buffer portion. The bolt unit includes an intermediate portion, a head portion at an end of the intermediate portion, and a threaded portion at an opposite end of the intermediate portion. The buffer portion surrounds the threaded portion and is located adjacent to an end of the bolt unit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a schematic side view of a loose resistant bolt structure according to a first embodiment of the present invention.

FIG. 2 conceptually shows the loose resistant bolt structure of FIG. 1 engaging with a nut.

FIG. 3 is a schematic side view of a loose resistant bolt structure according to a second embodiment of the present invention.

FIG. 4 is a schematic side view of a loose resistant bolt structure according to a third embodiment of the present invention.

FIG. 5 is a schematic side view of a bolt of prior art.

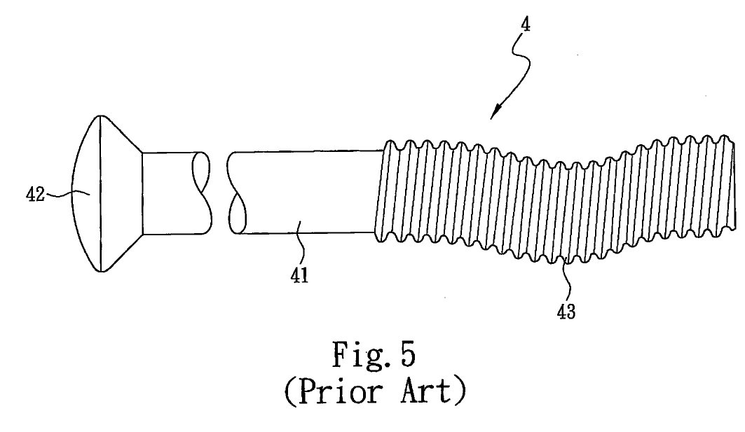

### DETAILED DESCRIPTION OF THE PREFERRED EMBODIMENTS

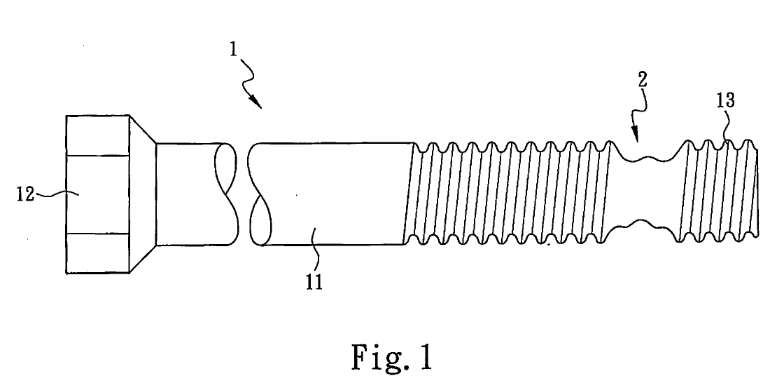

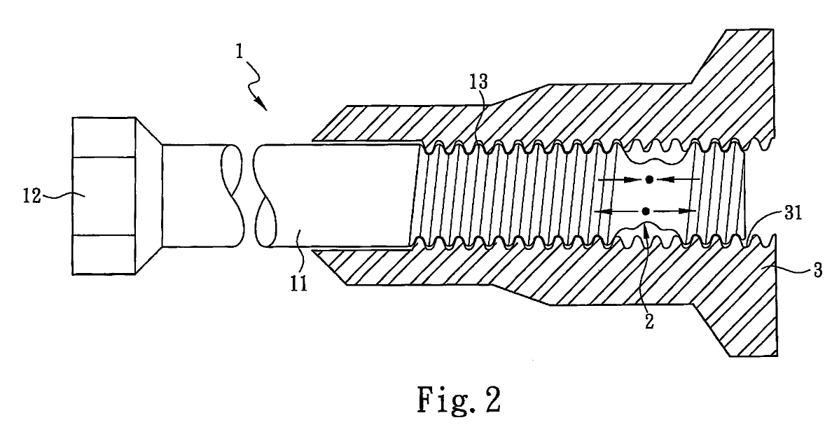

FIGS. 1 and 2 illustrate a loose resistant bolt structure according to a first embodiment of the present invention, which comprises a bolt unit 1 and a buffer portion 2.

The bolt unit 1 comprises an intermediate portion 11, a head portion 12 at an end of the intermediate portion 11, and a threaded portion 13 at an opposite end of the intermediate portion 11.

The buffer portion 2 surrounds the threaded portion 13 and is located adjacent to an end of the bolt unit 1. The buffer portion 2 has an outer diameter smaller than that of the threaded portion 13, and in this embodiment, is shaped of consecutive curves. The buffer portion 2 is made by forging, stamping and bending at an appropriate portion of the threaded portion 13 in sequence.

In practical use, the bolt unit 1 is made to a spoke of a wheel of a bicycle, a screw or other bolt device. As an example, the bolt unit 1 is made to a spoke of a bicycle (not shown). The head portion 12 of the bolt unit 1 engages with a hub (not shown). The threaded portion 13 engages with a nut 3 of a wheel rim of the bicycle. The intermediate portion 11 of the bolt unit 1 supports to engage the bolt unit 1 and the hub. When the threaded portion 13 engages with the nut 3, the threaded portion 13 is threadedly inserted into an inner thread 31. The buffer portion 2 forms a distinct pitch different from a pitch of the threaded portion 13. When the threaded portion 13 engages with the nut 3, the buffer portion 2 is drawn, shrunk or twisted, producing elastic stress and torsion force, thereby securing the threaded portion 13 to the nut 3, and avoiding the inner thread 31 of the nut 3 caused damage, and preventing from disengagement therebetween.

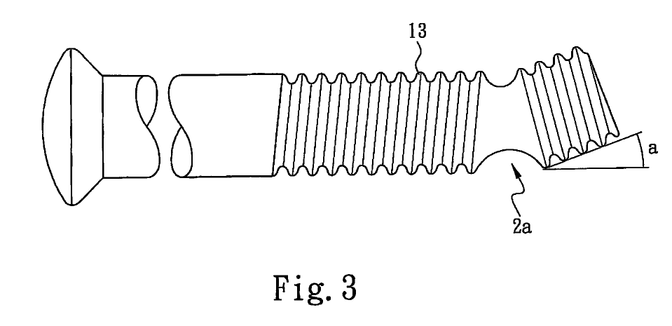

As seen from FIG. 3, which shows a loose resistant bolt structure according to a second embodiment of the present invention. A buffer portion 2a surrounding a threaded portion 13 is arcuate. The buffer portion 2a includes a front portion (not labeled) bending with a predetermined angle a from the threaded portion 13. The predetermined angle a is ranged from 3 degree to 5 degree. In this way, the buffer portion 2a can prevent from disengagement and can meet various functional needs.

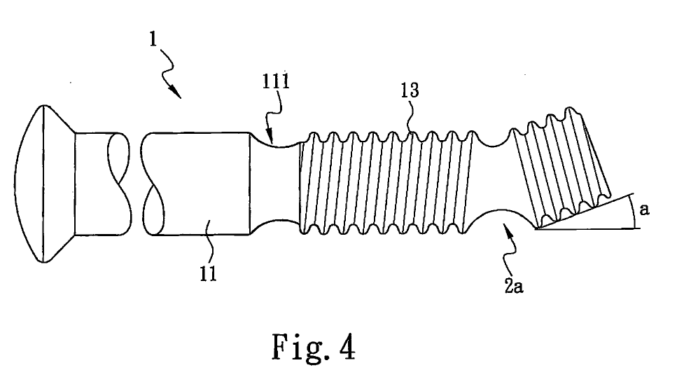

FIG. 4 shows a loose resistant bolt structure according to a third embodiment of the present invention. The loose resistant bolt of the third embodiment is similar to that of the second embodiment, and includes a buffer portion 2a having a front portion (not labeled) bending with a predetermined angle a. With reference to FIG. 4, an intermediate portion 11 of a bolt unit 1 has a stress-removal portion 111 at a position neighboring a threaded portion 13 of the bolt unit 1 for eliminating stress when the threaded portion 13 engages with a nut (not shown). The buffer portion 2a and the angle a cooperate to produce elastic stress and torsion force. As a result, the threaded portion 13 is secured to the nut (not shown) and resists loose, and will be able to avoid the inner thread 31 of the nut 3 caused damage during assembly.

It is of course to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A loose resistant bolt structure comprising:
a bolt unit including an intermediate portion, a head portion at an end of the intermediate portion, and a threaded portion at an opposite end of the intermediate portion; and
a buffer portion surrounding the threaded portion and being located adjacent to an end of the bolt unit.

2. The loose resistant bolt structure as claimed in claim 1, wherein the intermediate portion of the bolt unit has a stress-removal portion at a position neighboring the threaded portion for eliminating stress when the threaded portion engages with a nut.

3. The loose resistant bolt structure as claimed in claim 1, wherein the buffer portion is made by forging, stamping and bending at an appropriate portion of the threaded portion in sequence.

4. The loose resistant bolt structure as claimed in claim 1, wherein the buffer portion has an outer diameter smaller than that of the threaded portion of the bolt unit.

5. The loose resistant bolt structure as claimed in claim 1, wherein the buffer portion is shaped of consecutive curves.

6. The loose resistant bolt structure as claimed in claim 1, wherein the buffer portion is arcuate.

7. The loose resistant bolt structure as claimed in claim 1, wherein the buffer portion includes a front portion bending with a predetermined angle.

8. The loose resistant bolt structure as claimed in claim 7, wherein the predetermined angle is ranged from 3 degree to 5 degree.
